(19) United States
(12) Patent Application Publication
(10) Pub. No.: US 2026/0178242 A1
(43) Pub. Date: Jun. 25, 2026

(54) METHOD FOR OPERATING A CORRUGATOR, AND CORRUGATOR

(71) Applicant: BHS Corrugated Maschinen- und Anlagenbau GmbH, Weiherhammer (DE)

(72) Inventor: Simon Huber, Amberg (DE)

(21) Appl. No.: 19/123,836

(22) PCT Filed: Jul. 12, 2024
(86) PCT No.: PCT/EP2024/069831

§ 371 Date: Apr. 24, 2025

(30) Foreign Application Priority Data
Jul. 17, 2023 (DE) 102023206773.0

(51) Int. Cl. G06F 3/12; G05B 13/04; G06K 15/00; G06K 15/02

(52) U.S. Cl. CPC G06F 3/1208; G05B 13/048; G06F 3/1256; G06K 15/00; G06K 15/1843

(57) ABSTRACT

The invention relates to a method for operating a corrugator (2), wherein a plurality of webs (8, 8a) in a process portion (10) of the corrugator (2) are connected to form a corrugated cardboard web (12), wherein one of the webs (8, 8a) is printed with a printed image (38) which has a number of recurring printed image elements (40), wherein for the printed image (38) a target final dimension (M_{S}) is specified which is to be present downstream of the process portion (10), wherein the printed image (38) downstream of the process portion (10) has an actual final dimension (M_{I}) which is measured by means of a measuring unit (42), wherein by means of the actual final dimension (M_{I}) and the target final dimension (M_{S}) a final dimension fault (ΔM) is determined, wherein the corrugator (2) has a controller (4) which controls the process portion (10) depending on the final dimension fault (ΔM) in order to minimize said final dimension fault (ΔM). The invention also relates to a corresponding corrugator (2).

The invention relates to a method for operating a corrugator, as well as to a corresponding corrugator.

A corrugator is used to produce corrugated cardboard. For this purpose, a plurality of webs, more precisely paper webs, are each unrolled from a corresponding unwinder and connected to form a corrugated cardboard web along a number of process portions of the corrugator. The corrugator usually has a wet end, along which the webs are joined to form a corrugated cardboard web, and then a dry end, along which the corrugated cardboard web is finished. For example, the corrugated cardboard web is cut lengthwise in the conveying direction into a plurality of partial webs using an automatic slitter/scorer machine and provided with additional cuts and grooves. The partial webs are then cut into individual sheets using a cross cutter and are finally stored.

The sheets should be regularly provided with a print image, which can either be printed subsequently on the finished cut sheets (post-print) or in advance on one of the webs (pre-print). Especially in the case of pre-printing, the problem arises that the web and the print image on it shrink due to the processing in the corrugator. Shrinkage occurs in particular due to tempering and moistening of the web within the corrugator. During finishing, the print image may therefore no longer be dimensionally accurate in some circumstances. To compensate for this, it is conceivable to carry out the finishing in the dry end. However, this is disadvantageous because, on the one hand, a changeover, e.g. of the slitter/scorer, leads to rejects in the meantime and, on the other hand, the absolute dimensions of the sheets are also changed as a result. Therefore, it is desirable to directly compensate for the shrinkage of the print image. This is possible by printing the image already enlarged so that a certain amount of shrinkage is taken into account. The problem, however, is that then there is little room for variable operation of the corrugator. For example, a change in the web speed leads to changes in the contact times of the web during tempering and moistening and thus to a change in shrinkage. Accordingly, the web speed must be kept as constant as possible.

Against this background, it is an object of the invention to provide an improved method for operating a corrugator, and a correspondingly improved corrugator. In particular, the aim is to ensure that the print image is as dimensionally accurate as possible.

The object is achieved according to the invention by a method having the features according to claim 1 and by a corrugator having the features according to claim 13. Advantageous embodiments, further developments, and variants are the subject of the dependent claims. The statements in connection with the method also apply analogously to the corrugator. If steps of the method are specified below implicitly or explicitly, advantageous embodiments of the corrugator result in particular from the fact that the corrugator is designed to carry out one or more of these steps. For this purpose, the corrugator has in particular a correspondingly designed control unit.

An important aspect of the present invention is in particular a regulation of the shrinkage of the print image within the corrugator. This is in contrast to a regulation of the web speed, which can advantageously be varied almost arbitrarily by the regulation described here of the shrinkage, with at the same time a particularly dimensionally accurate print image. Overall, particularly flexible operation is possible with at the same time a dimensionally accurate print image.

The method according to the invention serves to operate a corrugator. In the method, a plurality of webs, in particular paper webs, are combined to form a corrugated cardboard web in a process portion of the corrugator. This process portion is in particular part of a wet end of the corrugator or corresponds to it. Downstream of the wet end, the corrugator has in particular a dry end which contains at least one further process portion of the corrugator.

One (i.e. at least one) of the webs is printed with a print image which has a number of recurring print image elements. This web is also called the printed web. The print image thus represents all the printing on the web. Printing can take place inside or outside the corrugator, in either case there is a pre-print. The print image elements are repeated in particular according to the number of sheets that are ultimately to be produced. The individual print image elements are, for example, logos, patterns, frames, decorations, markings, marks, registration marks, tax stamps, etc. The print image elements are in particular arranged repeatedly at least in one longitudinal direction of the web, i.e. in the conveying direction. It is also expedient for the print image elements to be arranged repeatedly in a transverse direction, i.e. perpendicular to the conveying direction and for a corresponding number of partial webs running alongside one another.

In the present case, it is assumed, without limitation of generality, that exactly one of the webs is printed and that this is a cover or lamination web of the corrugated cardboard web. However, the invention is also applicable to a plurality of printed webs, and the cover or laminated web does not necessarily have to be printed.

Within the scope of the method according to the invention, a target final dimension is specified for the print image, which should be present downstream of the process portion. The target final dimension is, for example, a distance between two in particular identical print image elements (equivalently: relative position to each other) or a dimension (e.g. size, length, width) of an individual print image element. The target final dimension indicates how the print image should actually be dimensioned when entering the dry end and specifically during finishing, and thus in particular on the finished sheet as well. It is also advisable to accept a predetermined tolerance for the target final dimension, e.g. +/−5%. The target final dimension is specified, for example, by a higher level controller of the corrugator based on known print data for the printed web or entered via a user interface. The higher level controller and/or the user interface are in particular part of the control unit of the corrugator. Optionally, an offset for the target final dimension is also specified analogously, e.g. for manual correction. The optimal target final dimension is determined experimentally, for example in a print test process separate from the actual operation, or is determined iteratively during operation or is specified based on experience.

The print image has an actual final dimension downstream of the process portion, which regularly differs from the target final dimension. The actual final dimension is measured with a measuring unit of the corrugator and a final dimension fault is determined, in particular calculated, using the actual final dimension and the target final dimension. The actual final dimension, i.e. the effective final dimension, is highly dependent on the processing within the process portion and is naturally subject to fluctuations. Accordingly, the mentioned final dimension fault results as the difference between the actual final dimension and the target final dimension, which fault is represented e.g. as a difference or as a scaling factor. Depending on how the process portion is guided, the actual final dimension is larger or smaller than the target final dimension.

According to the invention, the corrugator has a controller which controls the process portion depending on the final dimension fault in order to minimize this final dimension fault (i.e. the final dimension fault is minimized by means of the controller). The final dimension fault is therefore used directly or at least indirectly as a fault signal for the controller. The actual final dimension and the target final dimension are used directly or at least indirectly as an actual value or target value for the controller. The controller then outputs a control variable with which the process portion is controlled; examples of this are given below. If the process portion results in a varying shift or scaling of the print image and its individual print image elements, which in principle leads to a varying actual final dimension, this is compensated for by the controller.

Optionally, the controller only intervenes when the final dimension fault exceeds/falls below a certain limit value, which is defined by the tolerance mentioned above.

It is also particularly important in this case that the controller controls the process portion, i.e. one or more parts of the corrugator, and not a printer which is used to print the web. The regulation is therefore downstream of a printing process for printing the web and, advantageously, is also independent of it.

In a particularly preferred embodiment, the print image is printed with a print dimension which results from a target shrinkage and the target final dimension, so that the controller regulates a shrinkage of the print image (along the process portion) to the target shrinkage. Typically, a real, positive shrinkage occurs along the process portion, i.e. the target final dimension is smaller than the print dimension and the web is thus printed larger, this is also referred to as “enlarged print dimension.” This will also be assumed below, without limitation of generality. In principle, however, negative shrinkage is also possible, i.e. the target final dimension is larger than the print dimension; the statements apply analogously.

Printing with the enlarged print dimension allows a defined shrinkage to a certain extent. This extent is defined by a deviation of the print dimension from the target final dimension and is quantified with a compensation value, which indicates a difference between the print dimension and the target final dimension. The compensation value is, for example, a factor (scaling of the print dimension relative to the target final dimension) or a shift (difference between the print and target position of a print image element on the web). Accordingly, the print dimension and the target final dimension de facto specify a target shrinkage, namely the shrinkage that is permitted along the process portion so that the print dimension shrinks to the target final dimension. Analogously, an actual and possibly varying shrinkage downstream of the process portion then results in an actual shrinkage which may differ from the target shrinkage. The final dimension fault for the controller mentioned above is then also a measure of how the actual shrinkage deviates from the target shrinkage and is therefore also referred to as “shrinkage deviation.” By regulating the final dimension fault as described here, the shrinkage of the print image is then effectively regulated to the target shrinkage, so that a shrinkage regulation is realized. The target shrinkage is defined by the compensation value. The compensation value is expediently dependent on the paper type and/or grammage of the (printed) web.

The method described here requires that the target final dimension be specified. This is also fulfilled if the target shrinkage or the compensation value is specified, since this then automatically specifies the target final dimension via the known print dimension.

In a suitable design, the actual shrinkage is calculated from the print dimension and the actual final dimension and, analogously, the target shrinkage is calculated from the print dimension and the target final dimension, unless the target shrinkage is already directly specified. The actual shrinkage is then compared with the target shrinkage and the final dimension fault is calculated from this, e.g. as the difference or ratio of actual shrinkage and target shrinkage, or combined as the difference of actual shrinkage and target shrinkage in relation to the target shrinkage. The final dimension fault indicates the portion of the total shrinkage which distinguishes the actual shrinkage from the target shrinkage, i.e. is unintended and is to be compensated for.

Analogously and with equivalent results, the final dimension fault can also be determined directly from measurement and comparison of the actual final dimension and the target final dimension, e.g. according to (actual final dimension-target final dimension)/target final dimension. As is clear from these explanations, various configurations are possible and suitable with regard to the selection and processing of the actual final dimension and the target final dimension as well as the selection and determination of the final dimension fault.

In the present case, without limitation of generality, a corrugator is assumed having a plurality of system components as follows: a plurality of unwinders, with each of which one of the webs is unrolled, one or more single facers, with each of which one of the webs is corrugated and connected to another of the webs, a preheater and a gluing unit, with which the webs are glued together, and a heating and drawing portion (double facer), with which the glued-together webs are pressed together and dried, so that finally a corrugated cardboard web is output. The aforementioned system components are collectively referred to as the wet end. However, the exact configuration of the wet end is not important in this case, and it can also be designed differently. In this case, the wet end is followed by a dry end for finishing the corrugated cardboard web. Without limitation of generality, the present invention assumes a dry end with a slitter/scorer, a cross cutter downstream thereof, and a tray. However, other configurations are also possible. In the present case, it is assumed, without any limitation of generality, that the slitter/scorer cuts the corrugated cardboard web lengthwise in the conveying direction into a plurality of partial webs and optionally provides additional cuts and grooves and that the partial webs are then cut into individual sheets using the cross cutter and finally deposited in the tray.

The corrugator also has a control unit to carry out the process described here. In particular, the said controller is part of this control unit.

The measuring unit has a sensor unit for measuring the actual final dimension, preferably an optical sensor unit, e.g. a camera. The sensor unit is aimed in particular at the printed web and detects the print image passing through and thus also the individual print image elements. It is not absolutely necessary for the camera to monitor the entire web. The measuring unit also has an evaluation unit which is connected to the sensor unit and then determines the actual final dimension based on the corresponding sensor data from the sensor unit. The actual final dimension is measured in particular on a recurring basis. Since the print image has a periodicity at least in the conveying direction due to the recurring print image elements, a measurement of the actual final dimension is possible with the same periodicity. The optical measurement of the actual final dimension as described is particularly suitable for a measurement on the corrugated cardboard web, i.e. after the individual webs have been connected to one another, because an exact width measurement is no longer easily possible on this corrugated cardboard web.

Various designs are suitable for the actual final dimension. Particularly preferred is an embodiment in which the actual final dimension is a distance between two print image elements of the print image (distance measurement or relative position measurement) or in which the actual final dimension is a dimension of an individual print image element of the print image (size measurement or absolute position measurement). More generally, the actual final dimension is accordingly determined either as a relative dimension, e.g. distance, between two different or identical print image elements or as an absolute dimension, e.g. size, at a single print image element. Which of these two designs is used depends, among other things, on the specific job order and the print image elements actually present.

The webs and the corrugated cardboard web are generally fed through the corrugator in one conveying direction. Preferably, the actual final dimension is then measured in a transverse direction transverse to the conveying direction. The target final dimension in the transverse direction is also specified analogously. Typically, shrinkage in the transverse direction is greater by about a factor of 3 than in the conveying direction, so measurement in the transverse direction is easier. However, minimizing the final dimension fault benefits both directions in particular.

The regulation by means of the controller eliminates the final dimension fault by appropriately intervening in a processing procedure that takes place along the process portion. The regulation thus regulates the shrinkage, resulting from the processing along the process portion, to the target shrinkage. The processing procedure is therefore particularly flexible and the process portion can be managed in an accordingly variable manner without adversely affecting the dimensional accuracy of the print image.

In general, the process portion has at least one manipulated variable, which is adjusted with the controller to minimize the final dimension fault. The manipulated variable is assigned to a corresponding actuator, which is part of the process portion and which is controlled by the controller with a suitable control variable. The manipulated variable is preferably selected from the following: a wrap angle of the preheater; a quantity of heat supplied in the heating and drawing portion; a temperature or a steam pressure of a heating plate, in particular as part of the heating and drawing portion; a quantity of water, which is applied with a spray bar or steam spray bar of the corrugator (to at least one of the webs); a quantity of glue, which is applied with the gluing unit; a web speed of the corrugator, i.e. a conveying speed for one of the webs or for the corrugated cardboard web. Especially at the gluing unit, the web regularly swells due to the moisture introduced into the web via the glue. Spray and steam spray bars also have a corresponding swelling effect. Conversely, any heating and drying processes have a shrinking effect. Accordingly, suitable actuators which are controlled by the controller are generally those actuators which introduce heat and/or moisture into at least one of the webs, i.e. heating, cooling, drying and/or moistening devices. The manipulated variables mentioned include in particular a heating roller of the preheater, the mentioned heating plate of the heating and drawing portion, a glue application roller of the gluing unit, a spray bar or steam spray bar, a dryer, e.g. an IR or hot air dryer. In general, any system components that influence the shrinkage of the printed web are suitable actuators for the regulation described here.

The web speed also influences the shrinkage and thus the final dimension fault, since with varying web speed the contact time of the printed web with the various system components also varies and thus the web is tempered and moistened in a correspondingly fluctuating manner (at least if these system components are not operated in a precisely compensating manner). As already described above, the web speed is in principle a suitable manipulated variable for the regulation, but this limits the flexibility in the operation of the corrugator and may reduce its output quantity. Apart from a possible use of the web speed as a manipulated variable for the regulation described here, the web speed is also regularly varied for other reasons, so that a corresponding final dimension fault results. Such a final dimension fault due to a (time-) varying web speed is now advantageously minimized by means of the controller. Accordingly, the controller preferably controls the process portion independently of the web speed of the corrugator. This means in particular that the web speed is not an input parameter for the controller. In other words, the controller ensures optimum dimensional accuracy of the print image when operating at varying web speeds.

Another advantageous embodiment is one in which the target final dimension is specified depending on the web speed. In one possible embodiment, a plurality of consecutive speed intervals are defined for the web speed and each of these speed intervals is assigned a specific value for the target final dimension, e.g. by means of different values for the target shrinkage. This assignment is determined experimentally, for example. Depending on the actual web speed, a corresponding value is used for the target final dimension. This allows the regulation to be further optimized.

Optionally, the corrugator can have one or more additional (second) controllers in addition to the (first) controller described here, e.g. a warp controller or a gluing controller. In the case of a plurality of controllers, these then regularly have overlapping or even identical manipulated variables, so that the same manipulated variable is then influenced by a plurality of controllers. Two examples of regulation implemented with such additional controllers are a warp regulation to minimize warp of the finished sheets and a gluing regulation to regulate the glue application in the gluing unit. These regulations are intended to ensure the best possible quality of the corrugated cardboard web and the finished sheets and therefore require a certain degree of adjustability of the manipulated variable(s) used. The regulation described here is not intended to interfere adversely with such an additional regulation and is therefore appropriately subordinate to it. In a suitable embodiment, for this purpose the controller sets a manipulated variable of the process portion within a setting range and at least one limit value (e.g. minimum or maximum) of the setting range is specified by the warp regulation or the gluing regulation of the corrugator. In other words, the warp or gluing regulation with the second controller requires that the manipulated variable set by the first controller lies within certain limit values in order to achieve sufficient warp or gluing quality. The setting range is therefore limited to these limit values. Typically, the manipulated variable whose setting range is limited is used by both the first controller and the second controller, but this is not mandatory in itself; it is sufficient that a limit value is to be maintained for the manipulated variable apart from the (shrinkage) regulation, e.g. in order to ensure that the second controller can still adequately counteract with a different manipulated variable.

The sensor unit (or generally the entire measuring unit) is preferably arranged within the corrugator at a location downstream of which no significant change in the print image is to be expected. This is particularly the case downstream of the wet end and at the entrance to the dry end. In particular, the aforementioned heating and drawing portion of the corrugator marks one end of the wet end, so that the sensor unit is then arranged in a suitable configuration downstream of the heating and drawing portion. In general, the sensor unit is preferably arranged downstream of the wet end and/or in the dry end.

A particularly advantageous embodiment is one in which the sensor unit (or the entire measuring unit) is arranged upstream of the aforementioned slitter/scorer of the corrugator and wherein the measuring unit is additionally used to detect marks for the purpose of controlling the slitter/scorer. The terms “upstream” (before) and “downstream” (after) are to be understood relative to the direction of flow. The above-mentioned marks are printed in particular and serve as control marks for activating the slitter/scorer. Accordingly, the same sensor unit/measuring unit and optionally also the same marks can be used to control the cross cutter. The marks are, for example, bar marks, bar codes, QR codes or the like, and in general print image elements of the print image. These marks are also suitably used to measure the actual final dimension, but this is not mandatory and other print image elements can also be used for this purpose. More importantly, the measuring unit now performs at least two functions, namely the measurement of the actual final dimension and the detection of the marks for controlling a system component of the dry end, in this case the slitter/scorer.

The web can be printed with the print image outside or inside the corrugator; the latter is also referred to as inline printing and is preferred. For inline printing, a printer is integrated into the corrugator, which prints the print image onto one of the webs and thereby produces the printed web. The printer is preferably located immediately downstream of one of the unwinders and then prints on one of the webs before it is joined to the other webs to form the corrugated cardboard web. However, this is not mandatory. In particular, the printer is not part of the process portion, but outside of it. The printer itself preferably does not contain any print image regulation for adjusting the print dimension or the like. Regulation to the target final dimension is therefore not carried out with the printer, but outside it with the controller described here and by controlling the corrugator apart from the printer. Optionally, however, the printer is at least controlled in such a way, e.g. with the control unit, that in addition to the regulation already described the print dimension is also adjusted, in particular by varying the compensation value (e.g. via the target shrinkage) as required. For example, the corrugator is designed as a learning system that gradually adjusts the compensation value over a plurality of production orders. Alternatively or additionally, a statistical evaluation of the measured actual final dimensions (equivalently: actual shrinkage) is carried out, on the basis of which the compensation value is continuously adjusted. Overall, manual interventions in the operation are reduced to a minimum and the regulation is continuously optimized. Accordingly, cooperation with any other existing controllers described above can also be continuously improved.

If the printer has its own dryer for drying the print image, it is advantageous to use this dryer to achieve cornification of the web, which makes the web overall less susceptible to shrinkage. The same effect can also be achieved analogously with a dryer within the corrugator. The dryer should be located as far upstream as possible within the process portion or upstream outside it.

A corrugator according to the invention is designed to carry out a method as described above.

In the following, exemplary embodiments of the invention are explained in more detail with reference to a drawing. In the drawing:

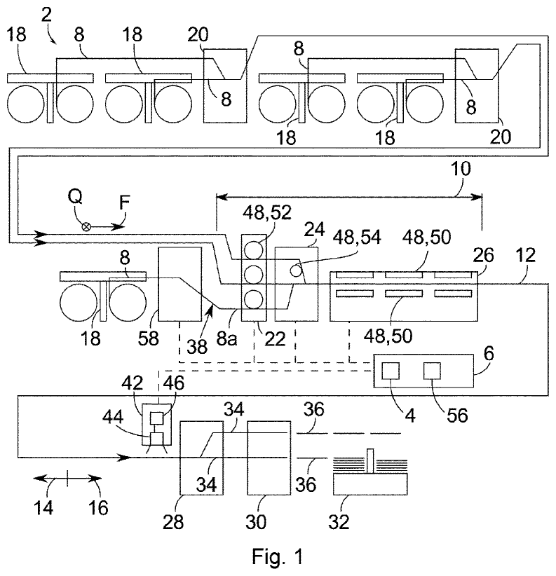

FIG. 1 shows a corrugator,

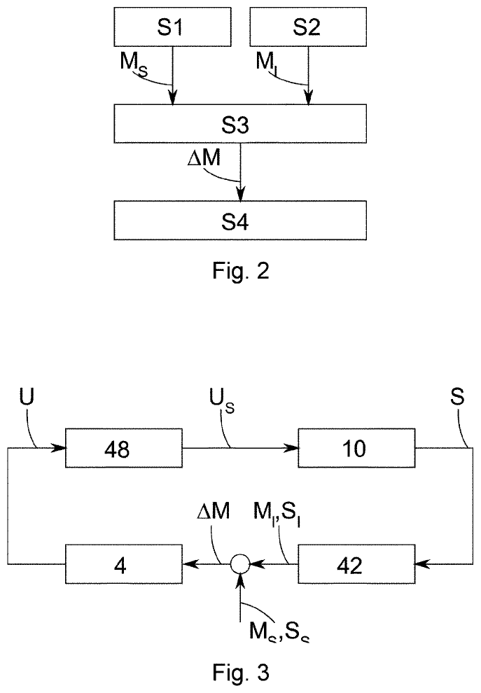

FIG. 2 shows a method for operating the corrugator of FIG. 1,

FIG. 3 shows a controller of the corrugator 2 of FIG. 1,

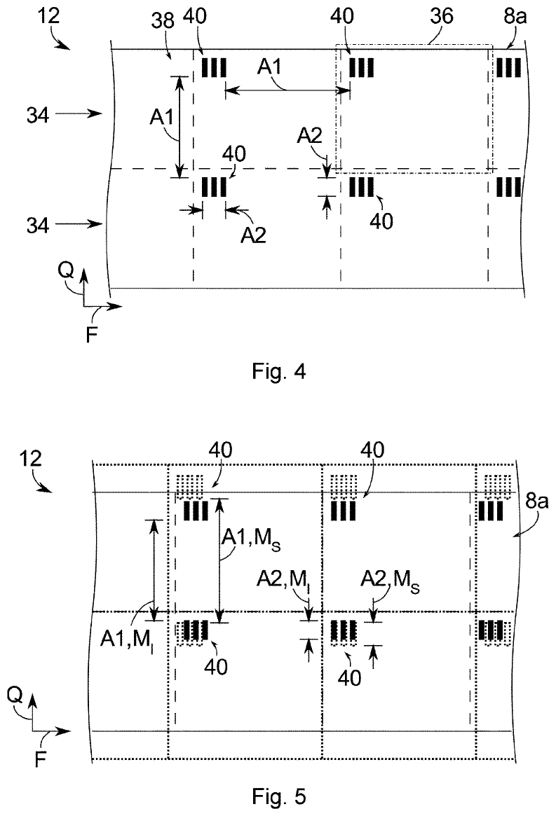

FIG. 4 shows a printed web in a plan view,

FIG. 5 shows actual and target final dimensions in comparison,

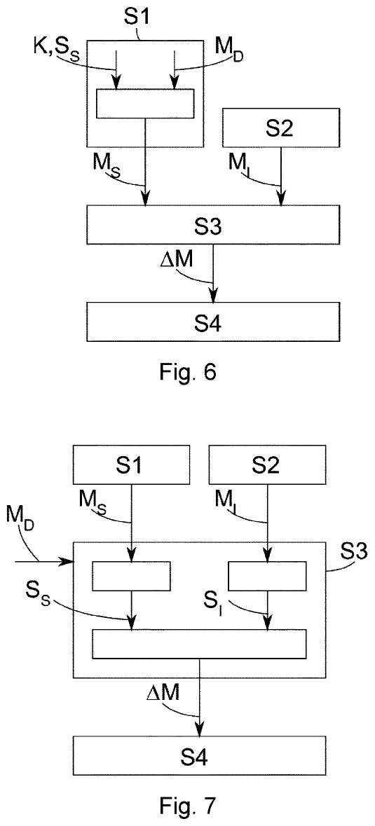

FIG. 6 shows variants of the method,

FIG. 7 shows another variant of the method.

FIG. 1 shows an exemplary embodiment of a corrugator 2 according to the invention. FIG. 2 shows an example of a method for operating such a corrugator 2, FIG. 3 shows an exemplary embodiment of a regulation which is part of this method and is implemented with a controller 4. The controller 4 is part of a control unit 6 of the corrugator. In the method, a plurality of webs 8, here paper webs, are connected to form a corrugated cardboard web 12 in a process portion 10 of the corrugator 2. This process portion 10 is part of a wet end 14 of the corrugator 2. Downstream of the wet end 14, the corrugator 2 has a dry end 16.

The corrugator 2 shown here as an example has a plurality of system components as follows: a plurality of unwinders 18, with each of which one of the webs 8 is unrolled, a plurality of single facers 20, with each of which one of the webs 8 is corrugated and connected to another of the webs 8, a preheater 22 and a gluing unit 24, with which the webs 8, 8a are glued together, and a heating and drawing portion 26 (double facer), with which the glued-together webs 8, 8a are pressed together and dried, so that finally a corrugated cardboard web 12 is output. The aforementioned system components form the wet end 14, which is then followed by the dry end 16 for finishing the corrugated cardboard web 12. In the embodiment shown here, the dry end 16 has a slitter/scorer 28, downstream therefrom a cross cutter 30, and further downstream a tray 32. FIG. 4 shows a detail of an exemplary corrugated cardboard web 12, wherein the dashed lines indicate the finishing by the slitter/scorer 28 and the cross cutter 30. With the slitter/scorer 28, the corrugated cardboard web 12 is divided lengthwise in the conveying direction F into a plurality of partial webs 34 and provided with additional cuts and grooves not shown here. The partial webs 34 are then cut into individual sheets 36 using the cross cutter 30 and are finally deposited in the tray 32.

One (i.e. at least one) of the webs 8 is printed with a print image 38 which has a number of recurring print image elements 40. This web 8a is also called the printed web 8a. In FIG. 4, the printed web 8a is a laminating web and is thus an uppermost layer of the corrugated cardboard web 12 shown there. The print image 38 represents the entire print on the web 8a. The print image elements 40 are repeated according to the number of sheets 36 that are ultimately to be produced. The individual print image elements 40 are, for example, logos, patterns, frames, decorations, markings, marks 42, registration marks, tax marks, etc. The print image elements 40 are arranged in recurring fashion both in the conveying direction F and in a transverse direction Q perpendicular to the conveying direction F and for a corresponding number of partial webs 34 running next to one another (two partial webs 34 in FIG. 4).

In a first step S1 of the method, for the print image 38 a target final dimension M_{S} is specified which should be present downstream of the process portion 10. The target final dimension M_{S} is for example a distance A1 between two identical print image elements 40 (equivalently: relative position to each other) or a dimension A2 (e.g. size, length, width) of a single print image element 40. The target final dimension M_{S} specifies how the print image 38 should actually be dimensioned when entering the dry end 16 and especially during finishing and on the finished sheet 36.

The print image 38 has an actual final dimension M_{I} downstream of the process portion 10 which regularly differs from the target final dimension M_{S}. This is illustrated in FIG. 5, which, as in FIG. 4, shows the corrugated cardboard web 12, but here the print image 38 has an actual final dimension M_{I} which differs from the target final dimension M_{S}, which is shown in dotted lines as an overlay, wherein for the sake of clarity not all distances A1 and dimensions A2 from FIG. 4 are shown. In FIG. 5 the actual final dimension M_{I} is smaller than the target final dimension M_{S}, but this can also be the other way around. The actual final dimension M_{I} is measured in a second step S2 with a measuring unit 42. Using the actual final dimension M_{I} and the target final dimension M_{S}, a final dimension fault ΔM is then determined in a third step S3. The actual final dimension M_{I} is highly dependent on the processing within the process portion 10 and is naturally subject to fluctuations. Accordingly, the mentioned final dimension fault ΔM results as the difference between the actual final dimension M_{I} and the target final dimension M_{S}, which fault is represented e.g. as a difference or as a scaling factor. Depending on how the process portion 10 is managed, the actual final dimension M_{I} is larger or smaller than the target final dimension M_{S}.

As is clear from the foregoing, various embodiments are suitable for the actual final dimension M_{I}, for example the distance A1 between two print image elements 40 of the print image 38 (distance measurement or relative position measurement) or the dimension A2 of an individual print image element 40 of the print image 38 (size measurement or absolute position measurement). More generally, the actual final dimension M_{I} is accordingly determined either as a relative dimension, e.g. the mentioned distance A1, between two different or identical print image elements 40 or as an absolute dimension, e.g. the mentioned dimension A2 (size), at a single print image element 40. Which of these two designs is used depends, among other things, on the specific job order and the print image elements 40 actually present.

The webs 8, 8a and the corrugated cardboard web 12 are generally guided through the corrugator 2 in the conveying direction F. The actual final dimension M_{I} is measured in the transverse direction Q perpendicular to the conveying direction F, but can also be measured in another direction. Analogously, in the present case the target final dimension M_{S} is also specified in the transverse direction Q. Typically, the shrinkage S in the transverse direction is greater by about a factor of 3 than in the conveying direction F, as also shown in FIG. 5.

In a fourth step S4, the controller 4 controls the process portion 10 depending on the final dimension fault ΔM in order to minimize it. The final dimension fault ΔM is therefore used as a fault signal for the controller 4; the actual final dimension M and the target final dimension M_{S} are used as an actual value or target value. An exemplary embodiment of the regulation realized with the controller 4 is shown in FIG. 3. The controller 4 then outputs a control variable U, which is used to control the process portion 10. If the process portion 10 results in a varying shift or scaling of the print image 38 and its individual print image elements 40 (e.g. as in FIG. 5), this is compensated for by the controller 4. Optionally, the controller 4 only intervenes when the final dimension fault ΔM exceeds/falls below a certain limit value.

In the exemplary embodiment shown here, the print image 38 is printed with a print dimension M_{D} which results from a target shrinkage S_{S} and the target final dimension M_{S} so that the controller 4 effectively regulates a shrinkage S of the print image 38 to the target shrinkage S_{S}. Printing with the enlarged print dimension M_{D} allows a defined shrinkage S to a certain extent (analogous to the shrinkage shown in FIG. 5 in connection with the actual final dimension M_{I} and target final dimension M_{S}). This extent is defined by a deviation of the print dimension M_{D} from the target final dimension M_{S} and is quantified with a compensation value K, which indicates a difference between the print dimension M_{D} and the target final dimension M_{S}. The compensation value K is, for example, a factor or a shift. Accordingly, the print dimension M_{D} and the target final dimension M_{S} specify a target shrinkage S_{S}, namely the shrinkage S which is allowed along the process portion 10, so that the print dimension M_{D} shrinks to the target final dimension M_{S}. Analogously, an actual and possibly varying shrinkage S downstream of the process portion 10 results in an actual shrinkage S_{I} which may differ from the target shrinkage S_{S}. The final dimension fault ΔM for the controller 4 mentioned above is then also a measure of how the actual shrinkage S_{I} deviates from the target shrinkage S_{S}, and is therefore also called “shrinkage deviation.” By regulating the final dimension fault ΔM as described here, the shrinkage S of the print image 38 is then effectively regulated to the target shrinkage S_{S} so that a shrinkage regulation is realized. The target shrinkage S_{S} is defined here by the compensation value K.

As described above, the target final dimension M_{S} is to be specified in step S1 of the method. This is also fulfilled if the target shrinkage S_{S} or the compensation value K is specified, since this then automatically specifies the target final dimension M_{S} via the known print dimension M_{D}. These variants of the method are illustrated in FIG. 6.

In a possible design, in the third step S3 the actual shrinkage S_{I} is calculated from the print dimension M_{D} and the actual final dimension M_{I} and, analogously, the target shrinkage S_{S} is calculated from the print dimension M and the target final dimension M_{S}, unless the target shrinkage is already directly specified. A corresponding variant of the method is illustrated in FIG. 7. The actual shrinkage S_{I} is then compared with the target shrinkage S_{S} and the final dimension fault ΔM is calculated from this, e.g. as the difference or ratio of the actual shrinkage S_{I} and target shrinkage S_{S}, or combined as the difference of the actual shrinkage S_{I} and target shrinkage S_{S} in relation to the target shrinkage S_{S} (i.e. ΔM=(S_{I}−S_{S})/S_{S}). The final dimension fault ΔM then indicates the proportion of the total shrinkage S which distinguishes the actual shrinkage S_{I} from the target shrinkage S_{S}, i.e. is unintended and is to be compensated for. Analogously and with equivalent results, the final dimension fault ΔM can also be determined directly from measurement and comparison of the actual final dimension M_{I} and the target final dimension M_{S}, e.g. according to (M_{I}−M_{S})/M_{S}. As is clear from these explanations and from FIGS. 2, 6 and 7, different designs are possible and suitable with regard to the selection and processing of the actual final dimension M_{I} and target final dimension M_{S}, as well as the selection and determination of the final dimension fault ΔM.

The measuring unit 42 has a sensor unit 44 for measuring the actual final dimension M_{I}, preferably an optical sensor unit, e.g. a camera. The sensor unit 44 is aimed in particular at the printed web 8a and detects the print image 38 passing through and thus also the individual print image elements 40. It is not absolutely necessary for the camera to monitor the entire web 8a. The measuring unit 42 also has an evaluation unit 46 which is connected to the sensor unit 44 and then determines the actual final dimension M_{I} based on the corresponding sensor data from the sensor unit 44. The actual final dimension M_{I} is measured on a recurring basis. Since the print image 38 has a periodicity at least in the conveying direction F due to the recurring print image elements 40, a measurement of the actual final dimension M_{I} is possible with the same periodicity.

The regulation by means of the controller 4 eliminates the final dimension fault ΔM by appropriately intervening in a processing procedure that takes place along the process portion 10. The regulation thus regulates the shrinkage S resulting from the processing along the process portion 10 to the target shrinkage S_{S}. In general, the process portion 10 has at least one manipulated variable U_{S} which is adjusted with the controller 4 to minimize the final dimension fault ΔM. The manipulated variable U_{S} is assigned to a corresponding actuator 48, which is part of the process portion 10 and which is controlled by the controller 4 with a suitable control variable U. The manipulated variable U_{S} is selected for example from the following manipulated variables U_{S}: a wrap angle of the preheater 22; a quantity of heat supplied in the heating and drawing portion 26; a temperature or a steam pressure of a heating plate 50; a quantity of water which is applied with a spray bar or steam spray bar of the corrugator 2 (to at least one of the webs 8, 8a); a quantity of glue which is applied with the gluing unit 24; a web speed of the corrugator 2. Especially at the gluing unit 24, a swelling of the web 8, 8a regularly occurs due to the moisture introduced into the web 8, 8a via the glue. Spray and steam spray bars also have a corresponding swelling effect. Conversely, any heating and drying processes have a shrinking effect. Accordingly, suitable actuators 48 which are controlled by the controller 4 are generally those actuators 48 which introduce heat and/or moisture into at least one of the webs 8, 8a, i.e. heating, cooling, drying and/or moistening devices. The mentioned manipulated variables U include a heating roller 52 of the preheater 22, the mentioned heating plate 50, a glue application roller 54 of the gluing unit 24, a spray bar or steam spray bar, a dryer, e.g. IR or hot air dryer. In general, any system components that influence the shrinkage S of the printed web 8a are suitable actuators 48 for the regulation described here.

The web speed also influences the shrinkage S and thus the final dimension fault ΔM, since with varying web speed the contact time of the printed web 8a with the various system components also varies and thus the web 8a is tempered and moistened in a correspondingly fluctuating manner. Apart from a possible use of the web speed as a manipulated variable U_{S} for the regulation described here, the web speed is also regularly varied for other reasons, so that a corresponding final dimension fault ΔM results. Such a final dimension fault ΔM due to a (time-) varying web speed is minimized in this case by means of the controller 4. Accordingly, the controller 4 controls the process portion 10 independently of the web speed of the corrugator 2. This means that the web speed is not an input parameter for the controller 4. In other words, the controller ensures an optimum dimensional accuracy of the print image 38 when operating at varying web speeds.

Also possible is a design in which the target final dimension M_{S} is specified in the first step S1 depending on the web speed. In one possible embodiment, a plurality of consecutive speed intervals are defined for the web speed and each of these speed intervals is assigned a specific value for the target final dimension M_{S}, e.g. by means of different values for the target shrinkage S_{S}. Depending on the actual web speed, a corresponding value is used for the target final dimension M_{S}.

The corrugator 2 shown here as an example has, in addition to the (first) controller 4 described here, one or more further (second) controllers 56, e.g. a warp controller or a gluing controller. In the case of a plurality of controllers 4, 56, these then regularly have overlapping or even identical manipulated variables U_{S}, so that the same manipulated variable U_{S} is then influenced by a plurality of controllers 4, 56. Two examples of regulation implemented with such additional controllers 56 are a warp regulation to minimize warp of the finished sheets 36 and a gluing regulation to regulate the glue application in the gluing unit 24. These regulations are intended to ensure the best possible quality of the corrugated cardboard web 12 and the finished sheets 36 and therefore require a certain degree of adjustability of the manipulated variable(s) U_{S} used. The regulation described here with the first controller 4 should not adversely interfere with such additional regulation with a further controller 56 and is therefore subordinate. In a possible embodiment, the controller 4 sets the manipulated variable U_{S} of the process portion 10 within a setting range and at least one limit value (e.g. minimum or maximum) of the setting range is specified by the warp regulation or the gluing regulation of the corrugator 2. In other words, the warp or gluing regulation with the second controller 56 requires that the manipulated variable U_{S} set by the first controller 4 lies within certain limit values in order to achieve sufficient warp or gluing quality. The setting range is therefore limited to these limit values. Typically, the manipulated variable U_{S}, whose setting range is limited, is used by both the first controller 4 and the second controller 56, but this is not mandatory in itself; it is sufficient that a limit value is to be maintained for the manipulated variable U_{S} apart from the regulation with the first controller 4, e.g. in order to ensure that the second controller 56 can still adequately counteract with a different manipulated variable.

In FIG. 1, the sensor unit 44—in this case even the entire measuring unit 42—is arranged within the corrugator 2 at a location downstream of which no significant change in the print image 38 is to be expected. This is the case downstream of the wet end 14 and at the inlet to the dry end 16. The heating and drawing portion 26 marks one end of the wet end 14, so that the sensor unit 44 is then arranged downstream of the heating and drawing portion 26. Generally, the sensor unit 44 is arranged downstream of the wet end 14 and/or in the dry end 16.

In the exemplary embodiment shown here, the sensor unit 44 is also arranged upstream of the slitter/scorer 28 and is additionally used to detect marks 40 for the purpose of controlling the slitter/scorer 28. These marks are also suitably used to measure the actual final dimension M_{I}, but this is not mandatory and other print image elements 40 can also be used for this purpose. The above-mentioned marks are printed and serve as control marks to activate the slitter/scorer 28. Optionally, the same sensor unit 44/measuring unit 42 and further optionally also the same marks 40 are used to control the cross cutter 30. The marks 40 in the present case are bar marks and generally print image elements 40 of the print image 38. The measuring unit 42 now performs at least two functions, namely the measurement of the actual final dimension M_{I} and the detection of the marks 40 for controlling a system component of the dry end 16, here the slitter/scorer 28.

The printing of the web 8 with the print image 38 can take place outside or inside the corrugator 2; the latter is shown in FIG. 1 and is referred to as inline printing. For inline printing, a printer 58 is integrated into the corrugator 2, which printer prints the print image 38 onto one of the webs 8 and thereby produces the printed web 8a. In the present case, the printer 58 is located immediately downstream of one of the unwinders 18 and then prints on one of the webs 8 before it is connected to the other webs 8 to form the corrugated cardboard web 12. However, this is not mandatory. The printer 58 is not part of the process portion 10, but is outside it. The printer 58 itself also does not contain any print image regulation for adjusting the print dimension M_{D} or the like. Regulation to the target final dimension M_{S} is therefore not carried out with the printer 58, but outside it with the controller 4 described here and by controlling the corrugator 2 apart from the printer 58. Optionally, however, the printer 58 is at least controlled in such a way, e.g. with the control unit 6, that in addition to the regulation already described the print dimension M_{D} is also adjusted, e.g. by accordingly varying the compensation value as required.

If the printer 58 has its own dryer for drying the print image 38, this dryer can also be used to achieve a cornification of the web 8a, which makes it overall less susceptible to shrinkage. The same effect can also be achieved analogously with a dryer within the corrugator 2. Such a dryer should be located as far upstream as possible within the process portion 10 or upstream outside it.

### LIST OF REFERENCE SIGNS

2 corrugator
4 (first) controller
6 control unit
8 web
8a printed web
10 process portion
12 corrugated cardboard web
14 wet end
16 dry end
18 unwinder
20 single facer
22 preheater
24 gluing unit
26 heating and traction portion
28 automatic slitter/scorer
30 cross cutter
32 tray
34 partial web
36 sheet
38 print image
40 print image element, mark
42 measuring unit
44 sensor unit
46 evaluation unit
48 actuator
50 heating plate
52 heating roller
54 glue application roller
56 (second) controller
58 printer
A1 distance
A2 size
F conveying direction
K compensation value
M_{D} print dimension
M_{I} actual final dimension
M_{S} target final dimension
Q transverse direction
S shrinkage
S_{I} actual shrinkage
S_{S} target shrinkage
S1 first step
S2 second step
S3 third step
S4 fourth step
U control variable
U_{S} manipulated variable

1. Method for operating a corrugator,
a. wherein a plurality of webs are connected in a process portion of the corrugator to form a corrugated cardboard web,
b. wherein one of the webs is printed with a print image which has a number of recurring print image elements,
c. wherein for the print image a target final dimension (M_{S}) is specified which is to be present downstream of the process portion,
d. wherein the print image downstream of the process portion has an actual final dimension (M_{I}) which is measured with a measuring unit,
e. wherein the actual final dimension (M_{I}) and the target final dimension are used to determine (M_{S}) a final dimension fault (ΔM),
f. wherein the corrugator has a controller which controls the process portion depending on the final dimension fault (ΔM) in order to minimize this final dimension fault (ΔM).

2. The method according to claim 1,
wherein the print image is printed with a print dimension (M_{D}) which results from a target shrinkage (S_{S}) and the target final dimension (M_{S}), so that the controller regulates a shrinkage (S) of the print image to the target shrinkage (S_{S}).

3. The method according to claim 1,
wherein the actual measurement (M_{I}) is a distance (A1) between two print image elements of the print image.

4. The method according to claim 1,
wherein the actual final dimension (M_{I}) is a dimension (A2) of an individual print image element of the print image.

5. The method according to claim 1,
wherein the webs and the corrugated cardboard web are guided-through the corrugator in a conveying direction (F),
wherein the actual final dimension (M_{I}) is measured in a transverse direction (Q) transverse to the conveying direction (F).

6. The method according to claim 1,
wherein the process portion has at least one manipulated variable (U_{S}), which is set with the controller to minimize the final dimension fault (ΔM) and which is selected from the following manipulated variables (U_{S}):
a. a wrap angle of a preheater of the corrugator,
b. a quantity of heat supplied in a heating and drawing portion of the corrugator,
c. a temperature of a heating plate of the corrugator,
d. a steam pressure of a heating plate of the corrugator,
e. a quantity of water which is applied by a spray bar or steam spray bar of the corrugator,
f. a quantity of glue which is applied by a gluing unit of the corrugator,
g. a web speed of the corrugator.

7. The method according to claim 1,
wherein the controller regulates the process portion independently of a web speed of the corrugator.

8. The method according to claim 1,
wherein the target final dimension (M_{S}) is specified depending on a web speed of the corrugator.

9. The method according to claim 1,
wherein the controller controls a manipulated variable (U_{S}) of the process portion within a setting range,
wherein at least one limit value of the setting range is predetermined by a warp controller or a gluing controller of the corrugator.

10. The method according to claim 1,
wherein the corrugator has a heating and drawing portion,
wherein the measuring unit has a sensor unit which is arranged downstream of the heating and drawing portion.

11. The method according to claim 1,
wherein the corrugator has a slitter/scorer, wherein the measuring unit has a sensor unit which is arranged upstream of the slitter/scorer and is additionally used for detecting marks for the purpose of controlling the slitter/scorer.

12. The method according to claim 1,
wherein a printer is integrated into the corrugator, which printer prints one of the webs with the print image.

13. A corrugator which is designed to carry out a method according to claim 1.
